(19) United States
(12) Patent Application Publication
(10) Pub. No.: US 2014/0208955 A1
(43) Pub. Date: Jul. 31, 2014

(54) DEVICES AND METHODS FOR CONTROLLING THE HEATING AND COOLING OF WATER IN BEVERAGE DISPENSERS

(71) Applicant: George M. Yui, Toronto (CA)

(72) Inventor: George M. Yui, Toronto (CA)

(21) Appl. No.: 13/858,911

(22) Filed: Apr. 8, 2013

Related U.S. Application Data
(63) Continuation-in-part of application No. 13/751,996, filed on Jan. 28, 2013.

(30) Foreign Application Priority Data
Mar. 29, 2013 (CN) 201310106511.7

(51) Int. Cl. B67D 7/80

(52) U.S. Cl. CPC B67D 7/80
USPC 99/295; 165/48.1

(57) ABSTRACT

Bottled water dispensers are disclosed that include a cabinet having an exterior portion and an interior portion. The interior portion of the cabinet is configured to house a water bottle in an upright position. The dispensers include a cold tank; at least one hot tank, which is connected to a heating element that is configured to heat the water that is contained within the hot tank; and a central processing unit (CPU), which is programmable by a user through a control panel. The CPU is configured to communicate with the heating element and cause power to be delivered to the heating element according to a defined protocol. The protocol may specify (i) the frequency and magnitude of pulsed energy to be delivered to the heating element from a power source; and (ii) a set temperature, or range of temperatures, for water contained within the hot tank and cold tank.

### CROSS-REFERENCE TO RELATED APPLICATIONS

This application claims priority to, and incorporates by reference, China patent application serial number 201310106511.7, filed on Mar. 29, 2013. This application is also a continuation-in-part application of U.S. patent application Ser. No. 13/751,996, filed on Jan. 28, 2013, which is incorporated herein by reference.

### FIELD OF THE INVENTION

The field of the present invention relates to certain devices and methods for controlling the heating and cooling of water, which is contained within bottled water and beverage dispensers.

### BACKGROUND OF THE INVENTION

Today, the water dispensers (and other beverage dispensers) that are found in offices and homes will include certain manual controls, which can be used to manage the heating and cooling of water that is contained within such dispensers. In many of these dispensers, the heating and cooling devices operate constantly, in order to heat and/or cool the water contained therein (e.g., when a dispenser includes both a hot tank and a cold tank, separate devices will operate constantly, in parallel with each other, to heat and cool the water in such tanks). In addition, when a dispenser includes a hot tank and a cold tank, the dispenser will often supply energy to the heating and cooling devices at the same time. Still further, many of the currently-available dispensers will operate in this manner during the daytime and evening hours (even when people may, for example, no longer be in an office setting and have a need to dispense water or other beverages from the dispenser). The foregoing aspects of currently-available dispensers result in significant and constant energy usage, which is not desirable in view of the world's decreasing energy supply (and the consequential rise in energy costs).

Accordingly, a significant and growing demand exists for improved devices and methods for heating and/or cooling water that is contained in a bottled water dispenser, particularly devices and methods that are more energy efficient.

### SUMMARY OF THE INVENTION

According to certain aspects of the present invention, bottled water dispensers are provided that include a cabinet having an exterior portion and an interior portion, with the interior portion of the cabinet being configured to house a water bottle in an upright position (preferably in the lower half of the cabinet). The water dispensers include a cold tank; at least one hot tank, which is connected to at least one heating element (coil) that is configured to heat the water that is contained within the hot tank; and a central processing unit (CPU), which is programmable by a user through a control panel on the dispenser. The CPU is configured to communicate with the heating element and to cause power to be delivered to the heating element according to a defined protocol. The invention provides that such protocol may specify, among other things, (i) the frequency and magnitude of pulsed energy (as opposed to a constant stream of energy) to be delivered to the heating element from a power source (to heat the water contained in the hot tank); and (ii) a set temperature, or a set range of temperatures, for water contained within the hot tank and cold tank.

According to further aspects of the present invention, the CPU may be programmed to execute other protocols as well. For example, another defined protocol may specify a rest period for the dispenser, with the rest period being a period of time during which the set temperature, or the set range of temperatures, for water contained within the hot tank is reduced relative to the set temperature(s) for a normal operating period of time (when the temperature may be held at an elevated temperature, when the dispenser is more likely to be used). Still further, the invention provides that the defined protocol may specify whether (a) the set temperature, or the set range of temperatures, for water contained within the hot tank takes precedence over water contained in the cold tank; or (b) the set temperature, or the set range of temperatures, for water contained within the cold tank takes precedence over water contained in the hot tank. This setting will cause the CPU to prioritize how energy is used, when the water temperatures in both the hot and cold tanks fall outside of the defined and desired ranges. According to yet further aspects of the invention, the defined protocol may further specify a total power usage limitation for the dispenser, including the frequency and magnitude of each pulse of energy provided to a hot and cold tank, as well as the aggregate maximum power usage over a period of time.

The invention provides improved devices and methods for conserving energy that are used to maintain cold and hot water temperatures in the types of water (and beverage) dispensers described herein. The invention provides that such energy preservation features are particularly important in those countries that place strict limits on the amount of energy that a home or office is allowed to use (or in areas where the amount of energy that can be used at any given time is lower than, for example, 1200 watts). In addition to energy preservation, the invention provides that maintaining the elevated temperature in a hot tank through periodic pulses of energy, as described herein, also reduces (or eliminates) unwanted “kettle noise,” which is otherwise associated with conventional heaters for hot tanks.

According to certain related aspects of the present invention, the invention provides that the water dispensers described herein may further be equipped with a coffee making device, which uses hot water provided by the hot water tank. The invention provides that such coffee making device will, preferably, consist of a single-serve coffee making device.

The above-mentioned and additional features of the present invention are further illustrated in the Detailed Description contained herein.

### BRIEF DESCRIPTION OF THE FIGURES

FIG. 1 is a general diagram of a side interior (cross-sectional) view of a non-limiting example of a combined water and coffee dispenser (having two hot tanks), which may be used in connection with the present invention.

FIG. 2 is a general diagram of a front interior (cross-sectional) view of a non-limiting example of a combined water and coffee dispenser (having two hot tanks), which may be used in connection with the present invention.

FIG. 3 is a general diagram of a side interior (cross-sectional) view of a non-limiting example of a combined water and coffee dispenser (having a single hot tank), which may be used in connection with the present invention.

FIG. 4 is a general diagram of a front interior (cross-sectional) view of a non-limiting example of a combined water and coffee dispenser (having a single hot tank), which may be used in connection with the present invention.

FIG. 5 is a diagram that illustrates a top view of the dispensers of FIGS. 1-4.

FIG. 6 is a flow diagram that illustrates the logic and functionality of the heater control algorithm described herein.

FIG. 7 is a flow diagram that illustrates the logic and functionality of the variable pulse control heating algorithm described herein.

FIG. 8 is a flow diagram that illustrates the logic and functionality of the heating power output interrupt mode described herein.

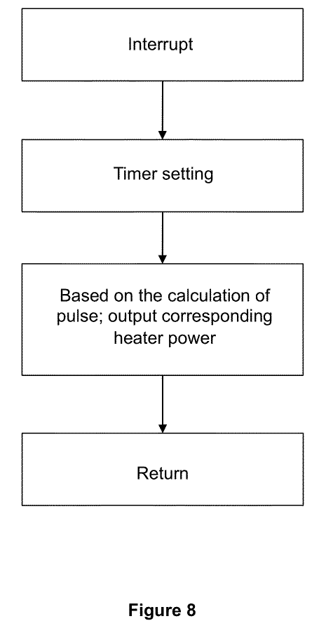

FIG. 9 is a diagram that illustrates a circuit, which is useful for the heating and cooling control modules described herein.

### DETAILED DESCRIPTION OF THE PRESENT INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

As described above, the present invention relates to certain devices and methods for controlling the heating and cooling of water, which is contained within bottled water and beverage dispensers. In order to properly understand the context in which these devices and methods of the present invention are employed, the following will provide a brief description of a non-limiting example of the type of water (and hot beverage) dispenser that may be used in connection with the present invention.

Water and Hot Beverage Dispensers

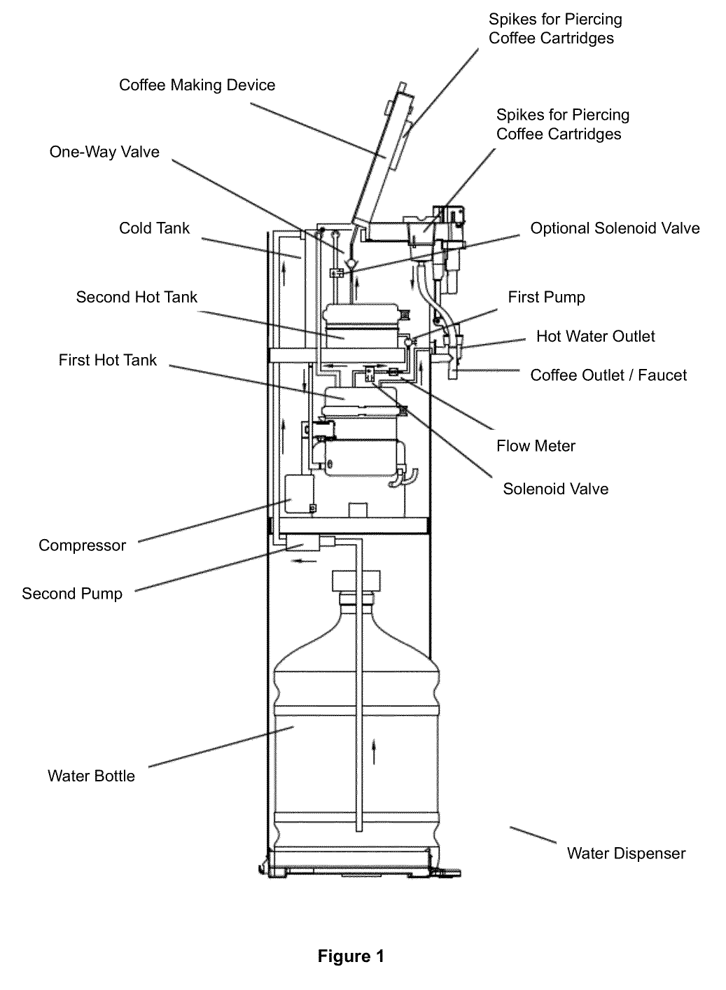

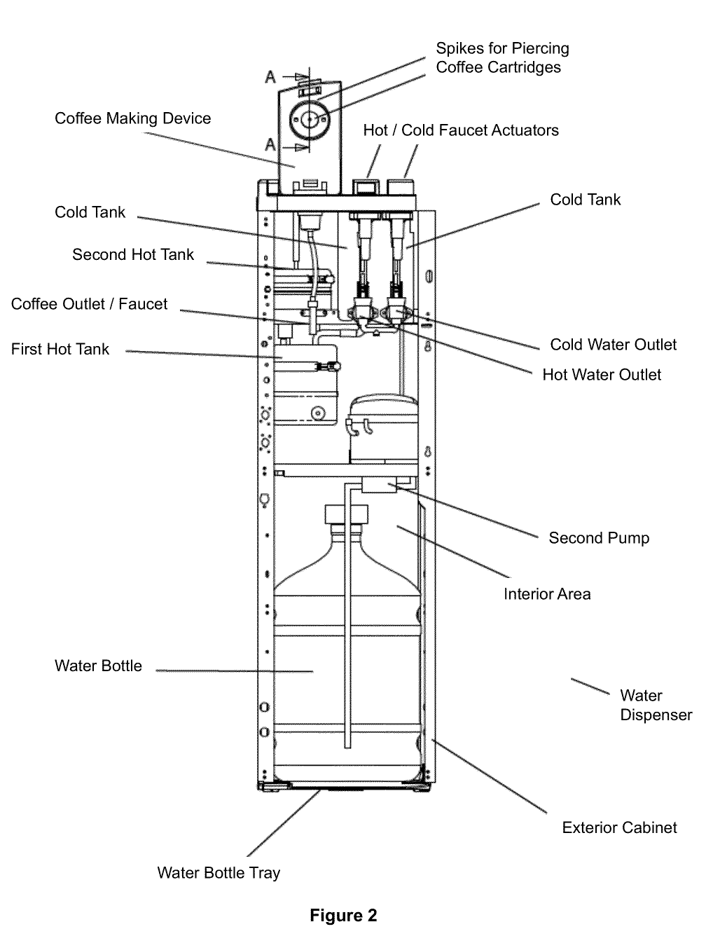

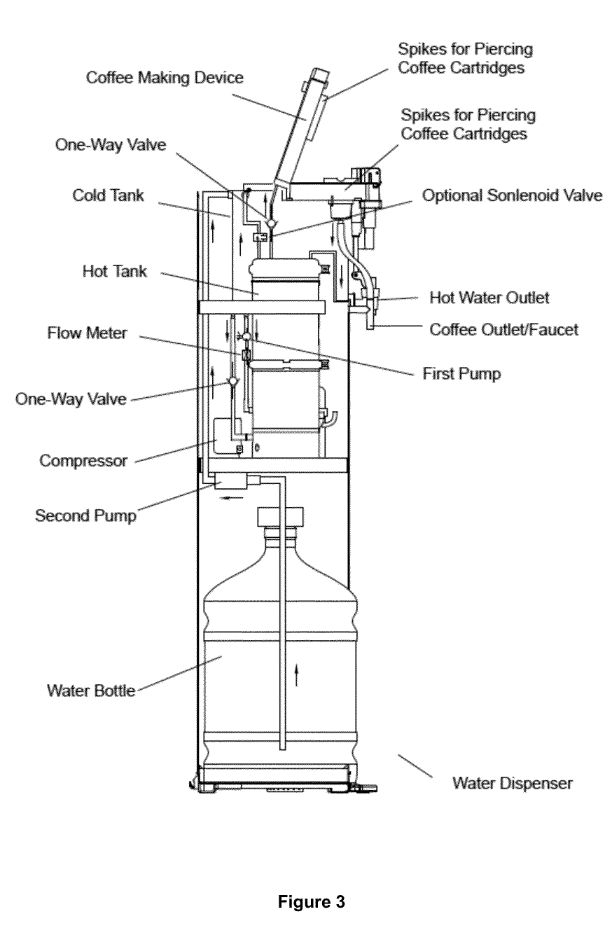

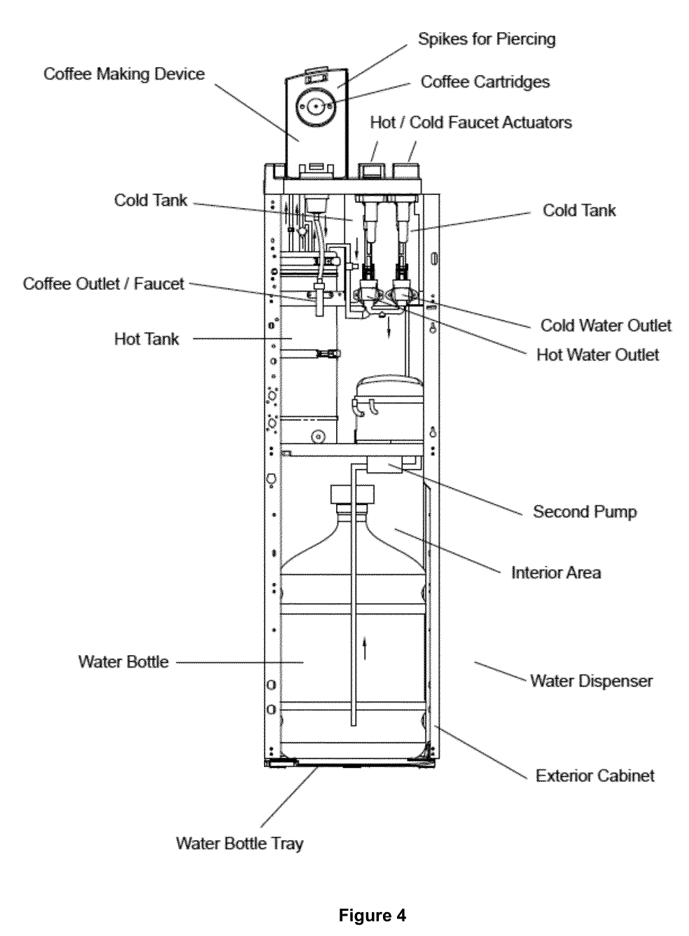

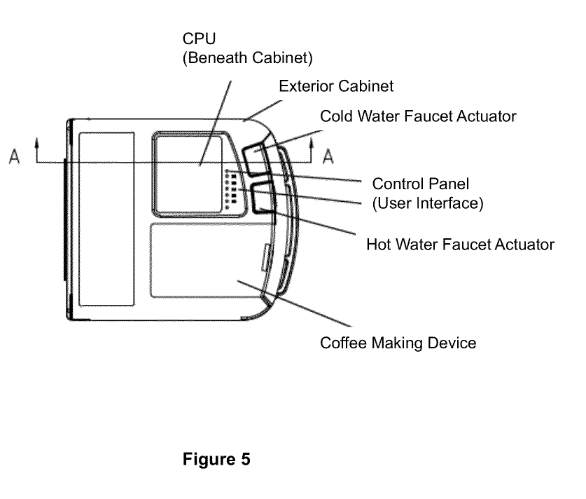

According to certain embodiments of the invention, devices and methods for controlling the heating and cooling of water may be used in the context of bottom-loading bottled water dispensers, which are further equipped with certain single-cup coffee making devices. For example, referring to FIGS. 1-5, the water dispensers may include an exterior cabinet; an interior space that is configured to house a water bottle within the bottom half of the dispenser; a cold water tank and means (actuator buttons) for dispensing cold water from such tank; and a first hot water tank and means (actuator buttons) for dispensing water from such hot tank. The cold tank is connected to an evaporator that is configured to cool the water that is contained within the cold tank, and the hot tank is connected to at least one heating element (e.g., a heating coil) that is configured to heat the water contained therein. In certain embodiments, the dispenser may include a second hot water tank that is configured to deliver hot water to a coffee making device (with the second hot water tank being configured to receive water from the first hot water tank). In the description below, regarding the devices and methods for controlling the heating and cooling of water of the present invention, the term “hot tank” encompasses both a single hot tank, or multiple hot tanks, each of which are configured to be heated (and for the temperature of the water contained therein to be controlled) as described herein.

The water dispensers may further include one or more flow sensors, which monitor the flow of water into, and volumes of water contained within, the cold and hot water tanks of the dispenser. The invention provides that the coffee making device is integrated into the water dispenser and, preferably, is a single-serve coffee making device. The invention provides that the dispensers will include a series of internal tubes/channels, which are configured to transfer water from the bottle of water into a cold tank, and from the cold tank into a hot tank, as well as separate tubes that allow users to dispense water (from a set of external faucet actuators) from the cold tank and hot tank (in addition to a separate and dedicated internal tube/channel that delivers water from the hot tank to the coffee making device). Similarly, the invention provides that the water dispenser will include one or more pumps, which can be operated to force water to travel from the bottle of water into a cold tank, and from the cold tank into a hot tank (as well as to transfer water from such hot tank to the coffee making device or to exit the dispenser through the external faucet actuators). The invention provides that such pumps will also serve to back-fill water that leaves the cold tank or hot water tank, as water is dispensed by users (or is used to produce a coffee beverage).

According to such aspects of the invention, when the water dispenser includes two separate hot tanks, the water that will eventually be used to make coffee may be held at a sufficiently high temperature, e.g., about 92-96 degrees Celsius, within the second hot water tank. The invention provides that replacement water that enters the second hot water tank, from the first hot water tank (which may hold the water contained therein at a lower temperature to conserve energy), may quickly be heated to the desirable coffee-making temperature, e.g., about 92-96 degrees Celsius, since the starting temperature will already be elevated from being held in the first hot water tank. This design also reduces the “waiting time” that is often associated with prior art coffee makers, since the water in the second hot tank is held at a temperature that may be effectively and immediately used to produce coffee. Alternatively, when the water dispenser of the present invention comprises a single hot water tank, the hot water tank will be configured to receive water from the cold tank, and then quickly heat the water to a temperature that is suitable for use in producing a coffee beverage as described herein.

Devices for Controlling the Heating and Cooling of Water

According to certain preferred embodiments of the present invention, devices and methods for heating and cooling the water that is contained within the water (and beverage) dispensers that are described herein are provided. In general, the present invention comprises: a central processing unit (CPU), a control panel, a heating control module, a cooling control module, at least one temperature sensor installed within the inner portion of at least one hot tank, and at least one temperature sensor installed within the inner portion of a cold tank. The invention provides that the central processing unit will be operably connected to the control panel, whereby a user may submit instructions to the central processing unit through the control panel. The central processing unit and control panel will, in turn, be configured to operate and communicate with the temperature sensor located in the hot tank, the temperature sensor located in the cold tank, the input end of the heating control module, and the input end of the cooling control module. The invention further provides that the output end of the heating control module is operably connected with the water dispenser heater (i.e., at least one heating coil), whereas the output end of the cooling control module is operably connected with the water dispenser cooling device (e.g., an evaporator).

The invention provides that the control panel will include a user interface, which allows users to selectively control the heating and cooling settings of the dispenser. More particularly, the invention provides that the temperature sensor disposed within the hot tank will monitor, and convey to the central processing unit, the water temperature in the hot tank. Similarly, the invention provides that the temperature sensor disposed within the cold tank will monitor, and convey to the central processing unit, the water temperature in the cold tank. As described further below, the central processing unit will be configured to compare actual water temperatures to the desired temperatures that are selected by the user (at a given point in time) and, if necessary, issue instructions to the water dispenser heater and water dispenser cooler to adjust the amount of energy that is provided to such tanks for the purpose of heating or cooling, as applicable, the water contained therein, until the selected desired temperatures and actual water temperatures are aligned—or substantially aligned within a defined range (as described further below).

According to certain preferred embodiments, the invention provides that a user may control whether the hot water temperature or cold water temperature should take precedence over the other. For example, if the user specifies (through the control panel) that the temperature of the hot water should take priority over the temperature of the cold water, and if the actual water temperatures in both the hot tank and cold tank fall outside of a defined range from the selected temperature settings, the central processing unit will instruct the heater to heat the water in the hot tank through the heating control module until the actual water temperature in the hot tank is within a defined range from the selected temperature setting (and, once the desired hot water temperature is achieved, the central processing unit will then instruct the cooling unit to cool the water in the cold tank through the cooling control module until the actual water temperature in the cold tank is within a defined range from the selected temperature setting). Conversely, if the user specifies (through the control panel) that the temperature of the cold water should take priority over the temperature of the hot water, and if the actual water temperatures in both the hot tank and cold tank fall outside of a defined range from the selected temperature settings, the central processing unit will first adjust the water temperature of the cold tank as described above, before moving on to adjust the water temperature in the hot tank.

Preferably, however, the invention provides that the heating and cooling units will work separately, and not simultaneously, to adjust water temperatures, which serves to reduce the total working power (and energy) that is consumed by the water dispensers of the present invention. In addition, the invention provides that users may define the working (heating and cooling) hours of the dispenser, through the control panel. The central processing unit will receive, store, and utilize such defined parameters, in combination with an internal clock, to manage when the dispenser will function to heat and cool the water contained therein (and when it will not).

According to further preferred embodiments, the invention provides that the heating control module is preferably configured to adjust (or maintain) the temperature of water contained in the hot tank by supplying abbreviated pulses (or bursts) of energy to the heating element (coil). More particularly, the central processing unit and heating control module are preferably configured to heat the water contained in the hot tank through short bursts of energy being provided to the heating element that heats the water, instead of a constant stream of energy. In some embodiments, when the water contained in the hot tank must be elevated, the magnitude of each energy burst may be increased and/or the frequency of such energy bursts may be increased—and, when the temperature must be quickly elevated, the heating control module may readjust and deliver a constant (full power) stream of energy. However, when the dispenser is in a “resting state” (with the timing and duration of such “resting state” specified by a user through the control panel), or once the water temperature in the hot tank has reached the desired temperature, the water temperature may thereafter be maintained by supplying a periodic pulse of energy as described above.

The invention provides that such features dramatically reduce the total energy consumption of these dispensers, while still having the ability to maintain water temperatures within a desired range. For example, when the maximum wattage usage is set at 1200 watts, the dispenser may be programmed (through the control panel) to only use 300 watts during a “resting state” (e.g., during the evening hours, when the dispenser is not being used), or once the water temperature in the hot tank has reached the desired temperature. When and if a cup of hot water is drawn from the dispenser (or when the dispenser is used to prepare a hot beverage, such as coffee), the central processing unit may, if necessary, instruct the heating control module to supply a full stream of energy to quickly heat the water in the hot tank in such instances and, after the beverage is dispensed, return to a “resting state” protocol. This energy preservation feature is particularly important in those countries that place strict limits on the amount of energy that a home or office is allowed to use (or in areas where the amount of energy that can be used at any given time is lower than in many other countries, e.g., lower than 1200 watts). In addition to energy preservation, the invention provides that maintaining the elevated temperature in the hot tank through periodic pulses of energy also reduces (or eliminates) unwanted “kettle noise,” which is otherwise associated with conventional heaters for hot tanks.

Heating Control Logic and Processes

The above-described energy saving methods can be implemented through the use of fuzzy logic proportional-integral-derivative (PID) controllers, which utilize a variable pulse control heating algorithm. More particularly, the central processing unit described herein is configured to drive the various parameters of a PID controller, namely, the proportional (P), integral (I), and derivative (D) values. Such controller is used for the purpose of adjusting the wattages provided to the heating element (coil) used in the dispenser, in a manner that conserves the expenditure of energy, yet is adapted to heat water in accordance with the present invention.

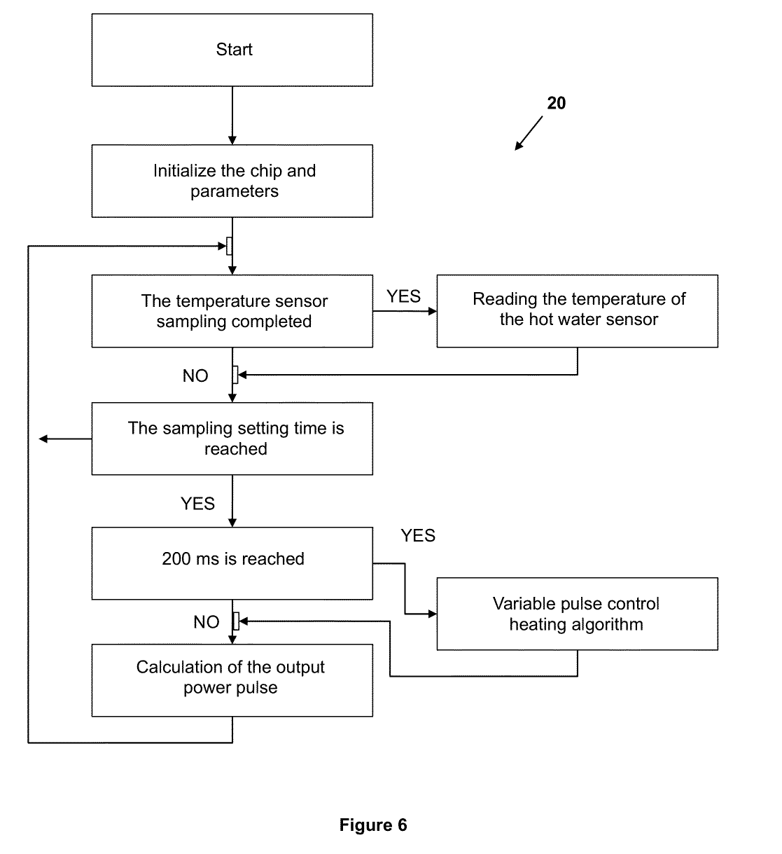

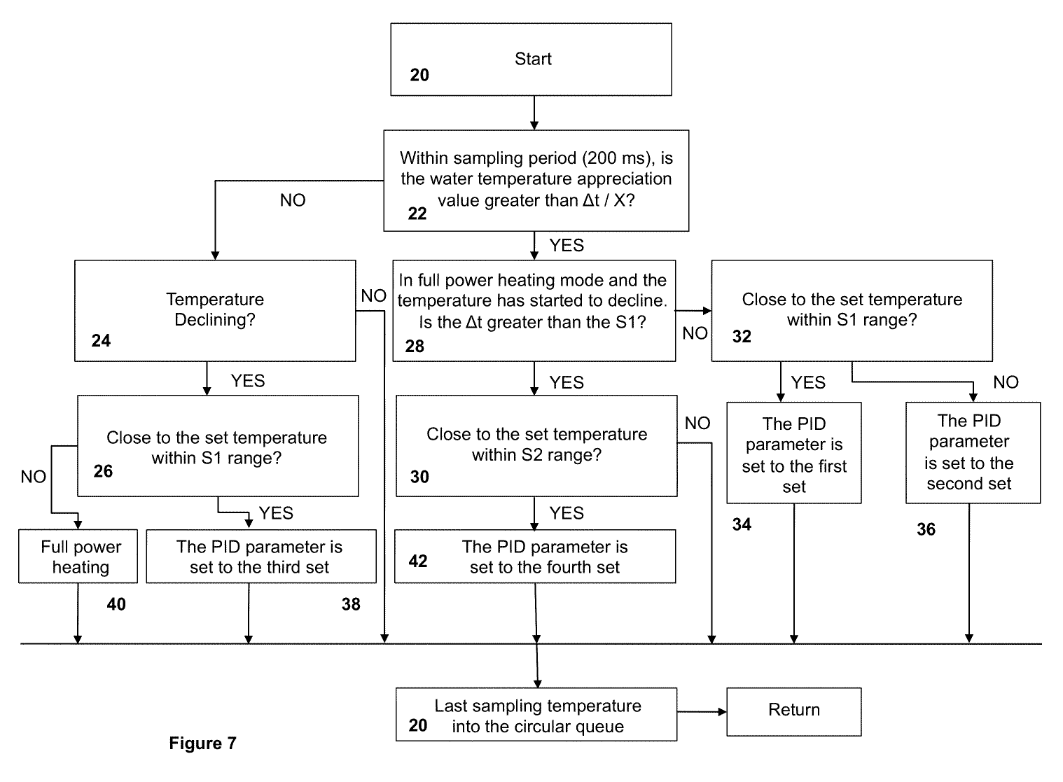

As used herein, the delta temperature (Δt) value represents the difference between the desired set temperature (as specified by a user through the control panel) and the actual temperature of the water. Referring now to FIGS. 6 and 7, the first step 20 of the water temperature controlling procedures described herein involves a temperature sensor obtaining the actual water temperature in the hot tank, and then communicating such information to the central processing unit (CPU). Next, the CPU determines if the appreciation of the water temperature is greater than Δt/X in a sampling period (e.g., 200 ms) 22, whereby X is the default temperature coefficient (a non-limiting example of such coefficient is X=15). As used herein, the term “appreciation” of the water temperature refers to the change (e.g., rise) in water temperature over a specified period of time.

The invention provides that if the CPU determines 22 that the appreciation of the water temperature within the sampling period is greater than Δt/X, then the current water temperature has started to decline. If and when the dispenser is operating in full power mode, the CPU next determines 28 if the Δt value is greater than an S1 setting (with S1 being the first adjustment temperature differential setting, as described further below). If the Δt value is not greater than an S1 setting, then the CPU determines if the actual water temperature is close (within the S1 setting range, i.e., less than or equal to the S1 setting) to the desired set temperature 32. If the actual water temperature is close (within the S1 setting range) to the desired set temperature, then the PID parameters are adjusted to a “first set” 34, as described below; whereas, if the actual water temperature is not close (within the S1 setting range) to the desired set temperature, then the PID parameters are adjusted to a “second set” 36, as described below. In both instances, after the PID parameters are adjusted to the first set 34 or second set 36, the heating control logic will then restart after a defined period of time.

If the Δt value is determined to be greater than the S1 setting 28, then the CPU instructs the heating element to activate to full power heating. In addition, the CPU determines 30 if the Δt is less than or equal to S2 (with S2 being the second adjustment temperature differential setting). If the Δt is less than or equal to the S2 setting, then the PID parameter is set to the “fourth set” of PID parameters 42, and the heating control logic will then restart after a defined period of time. If the Δt is greater than the S2 setting, then the heating control logic will then restart.

The invention provides that if the CPU determines 22 that the appreciation of the water temperature within the sampling period is not greater than Δt/X, the CPU will determine if the current water temperature has started to decline 24. If not, then the heating control logic will restart after a defined period of time. If the CPU determines that the current water temperature has started to decline 24, then the CPU determines 26 if the actual water temperature is close (within the S1 setting range) to the desired set temperature. More particularly, the CPU will determine 26 if the Δt is less than or equal to the S1 setting. If the CPU determines that the Δt is less than or equal to the S1 setting, then the PID parameter is set to a “third set” of parameters 38, as described further below, and the heating control logic will then restart after a defined period of time. If the CPU determines that the Δt is more than the S1 setting, the CPU instructs the heating element to activate to full power heating 40, and the heating control logic will then restart after a defined period of time.

The invention provides that the CPU may be programmed with any combination of desired first (S1) and second (S2) adjusting temperature difference settings. Preferably, however, the invention provides that the first (S1) setting is less than the second (S2) adjusting temperature difference setting. In certain exemplary embodiments, the invention provides that the first setting (S1) is 32.9 Fahrenheit, whereas the second setting (S2) is 33.8 Fahrenheit. Similarly, the invention provides that the CPU may be programmed with the desired PID parameters and, optionally, being changed as desired. In certain exemplary embodiments, the invention provides that the PID parameters, referenced above, include those shown in the table below.

| | P value | I value | D value |
|---|---|---|---|
| First Parameters | 15 | 2 | 185 |
| Second Parameters | 40 | 10 | 255 |
| Third Parameters | 10 | 4 | 200 |
| Fourth Parameters | 35 | 82 | 250 |

Circuits for Controlling the Heating and Cooling of Water

The invention further encompasses certain novel circuitry, which may be used to construct and employ the devices and methods described above. The beneficial attributes of the circuitry described herein include: (1) that it can bifurcate heating and cooling operations for the water dispensers described herein (based upon the needs and parameters specified by users), (2) that it is configured to reduce the working power of such water dispensers and lower the net electricity load of the dispensers; and (3) it is configured to control the operations of heating and cooling elements, in accordance with defined hours (including heating and cooling hours) specified by a user through the control panel (which also conserves energy).

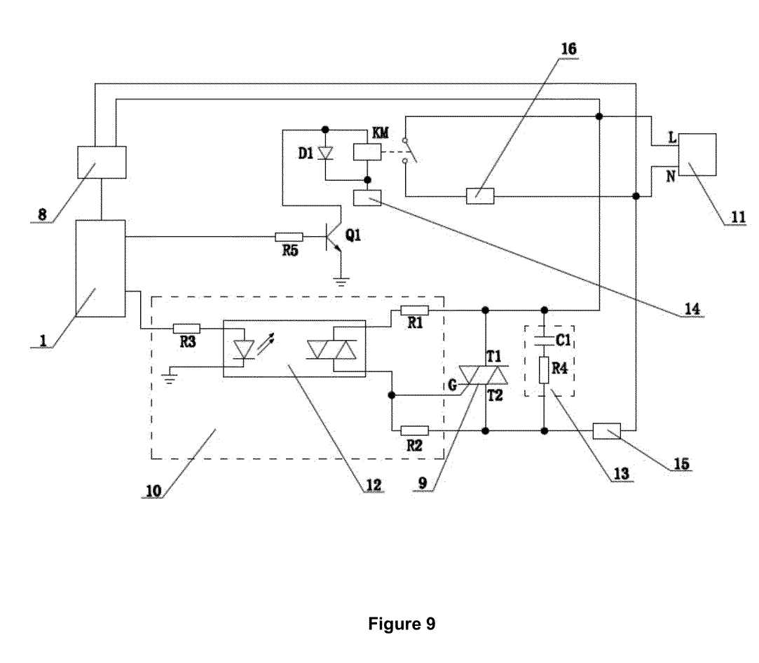

More specifically, and referring now to FIG. 9, the invention provides that the heating control module will preferably employ an over zero testing module 8, dual-direction controllable silicon 9, a first control module of dual-direction controllable silicon 10, and a second control module of dual-direction controllable silicon 10, which includes a photoelectricity coupling dual-direction controllable silicon drive 12, resistor R1, resistor R2, resistor R3, and a surge absorbing circuit 13 (which includes capacitor C1 and resistor R4). The invention provides that two input terminals of the over zero testing module 8 are connected with a firing line L of an AC power source 11 and a zero line N. Still further, the invention provides that the output terminals of the over zero testing module 8 are connected with input terminals of the central processing unit.

Still referring to FIG. 9, the invention provides that an anode of a transmitting end of the photoelectricity coupling dual-direction controllable silicon drive 12 will be connected with a first output end of the central processing unit via resistor R3. The invention provides that the cathode transmitting end of the photoelectricity coupling dual-direction controllable silicon drive 12 will be connected with the ground, while the receiving end of the photoelectricity coupling dual-direction controllable silicon drive 12 is connected with the first anode T1 of the dual-direction controllable silicon 9 via resistor R1. The invention provides that the other end of the photoelectricity coupling dual-direction controllable silicon drive 12 is connected with an end of resistor R2 and control pole G of the dual-direction controllable silicon 9, while the other end of resistor R2 is connected with the second anode T2 of the dual-direction controllable silicon 9. The invention provides that an end of the capacitor C1 is connected with the first anode T1 of the dual-direction controllable silicon 9 and fire line L of AC power source 11, while the other end is connected with an end of resistor R4 (and the other end of resistor R4 is connected with the second anode T2 of the dual-direction controllable silicon 9 and a first end of heater 15, with the other end of heater 15 being connected with the zero line N of the AC power source 11).

As explained above, the invention provides that users may define working power parameters of the heater 15 (e.g., heating coil) via the control panel. The over zero testing module 8 will test a zero point of the AC power source 11, and send a trigger pulse to the central processing unit every half AC period. The invention provides that the central processing unit is configured to adjust the working power of the heater 15 by modulating the conducted AC power wave of the dual-direction controllable silicon 9 and disconnected AC power wave per second. The invention provides that the photoelectricity coupling dual-direction controllable silicon drive 12 will be effective to isolate electricity; the resistors R1 and R3 are configured to limit electricity flow; and resistor R2 will be configured to prevent dual-direction controllable silicon 9 from false triggering. The invention provides that the surge absorbing circuit 13 will be configured to prevent surge voltage from damaging the dual-direction collectable silicon 9.

Still referring to FIG. 9, the invention provides that the cooling control module will include a relay KM, transistor Q1, diode D1 and resistor R5. The invention provides that the second output end of central processing unit will be connected with transistor Q1 via resistor R5, with the transmitting end of transistor Q1 being connected with the ground. The invention provides that the collector of transistor Q1 will be connected with the anode of diode D1 and one circle end of the relay KM, with the other circle end of relay KM being connected with the cathode of diode D1 and the DC power source 14 of the water dispenser. The invention provides that the end of the opening point of the relay KM will be connected with the firing wire L of the AC power source 11, with the other end being connected with one end of the cooler 16, with the other end of cooler 16 being connected with a zero line N of the AC power source 11.

According to these embodiments, the invention provides that when the second output end of the central processing unit outputs an elevated amount of electricity, transistor Q1 is conducted, the relay KM circle is connected with electricity, the opening point of relay KM is closed, and the cooler 16 starts operating. Similarly, when the second output end of the central processing unit outputs a reduced amount of electricity, transistor Q1 is disconnected, the relay KM circle is disconnected with electricity, the opening point of relay KM is opened, and the cooler 16 is deactivated.

The many aspects and benefits of the invention are apparent from the detailed description, and thus, it is intended for the following claims to cover all such aspects and benefits of the invention, which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottled water dispenser, which comprises:
(a) a cabinet having an exterior portion and an interior portion, wherein the interior portion of the cabinet is configured to house a water bottle in a bottom half of the interior portion of the cabinet in an upright position;
(b) a cold tank that is configured to receive water from the water bottle;
(c) at least one hot tank that is configured to receive water from the cold tank, which is connected to a heating element that is configured to heat the water that is contained within the hot tank; and
(d) a central processing unit, which is programmable by a user through a control panel, wherein the central processing unit is configured to communicate with the heating element and cause power to be delivered to the heating element according to a defined protocol, wherein said protocol specifies: (i) a frequency and magnitude of pulsed energy to be delivered to the heating element from a power source; and (ii) a set temperature, or a set range of temperatures, for water contained within the hot tank and cold tank.

2. The bottled water dispenser of claim 1, wherein the protocol further specifies a rest period, wherein the rest period is a period of time during which the set temperature, or the set range of temperatures, for water contained within the hot tank is reduced relative to a temperature that is associated with a normal operating period of time.

3. The bottled water dispenser of claim 2, wherein the protocol further specifies whether:
(a) the set temperature, or the set range of temperatures, for water contained within the hot tank takes precedence over water contained in the cold tank; or
(b) the set temperature, or the set range of temperatures, for water contained within the cold tank takes precedence over water contained in the hot tank.

4. The bottled water dispenser of claim 3, wherein the protocol further specifies a total power usage limitation for the dispenser.

5. The bottled water dispenser of claim 4, wherein the total power usage limitation may comprise (a) a specific or maximum amount of energy that may be delivered with each pulse of energy; (b) an aggregated maximum amount of energy that may be delivered over a defined period of time; or (c) a combination of (a) and (b).

6. The bottled water dispenser of claim 5, which further comprises a coffee making device located on a top side of the cabinet, which is configured to (a) receive water from the hot tank, (b) receive a disposable cartridge of coffee that contains coffee grinds; and (c) cause hot water to contact the coffee grinds to produce a coffee beverage.

7. The bottled water dispenser of claim 6, which further comprises one or more taps, which are configured to dispense cold water from the cold tank; hot water from the hot tank; and coffee beverage from the coffee making device.
